(19) United States
(12) Patent Application Publication
(10) Pub. No.: US 2026/0310009 A1
(43) Pub. Date: Oct. 8, 2026

(54) STABLE STRUCTURE DESIGN OF CONTACT LENS

(71) Applicant: BRIGHTEN OPTIX CORP., Taipei (TW)

(72) Inventors: Wen-Kai LI, Taipei (TW); Wen-Pin LIN, Taipei (TW); RICHARD I-TSUNG WU, Taipei (TW)

(21) Appl. No.: 19/448,584

(22) Filed: Jan. 14, 2026

Related U.S. Application Data
(62) Division of application No. 18/330,916, filed on Jun. 7, 2023.

(51) Int. Cl. G02C 7/04

(52) U.S. Cl. CPC G02C 7/048

(57) ABSTRACT

A stable structure design of contact lens includes a central optical zone, a peripheral positioning zone and an edge zone. The central optical zone is located at the center of a contact lens. The peripheral positioning zone surrounds the outside of the central optical zone, and the peripheral positioning zone surrounds the outside of the central optical zone and the inside of the edge zone along the axial direction to form a surface with at least one different thickness. The edge zone surrounds the peripheral positioning zone.

This Application is a Divisional Application of co-pending U.S. patent application Ser. No. 18/330,916, filed on Jun. 7, 2023, for which priority is claimed under 35 U.S.C. § 120, the entire contents of all of which are hereby incorporated by reference.

### BACKGROUND OF THE INVENTION

### 1. Field of the Invention

The present invention relates to contact lens technology, and more particularly to a stable structure design of contact lens for stable wearing through different thicknesses of the peripheral positioning zone. In the peripheral positioning zone of the contact lens and rotate axially along the outside of the central optical zone, at least one preset thickness zone and preset thickness value are sequentially obtained for making the front surface of different thickness of the peripheral positioning zone to achieve the purpose of stable wearing and not easy to decentration.

### 2. Description of the Related Art

Electronic Product Development connect people's daily lives to technology and enhance lifestyle/convenience. Especially the heavy use of electronic products results in the popularization of communication and internet technology applications. Many people immerse themselves in the use of 3C electronic products. Mobile phone overuse is seen among certain office workers, students, middle aged and elderly people. People everywhere are beginning to lose patience with the phenomenon known as phubbing: snubbing others in a social setting by checking your phone. Mobile phone overuse can also lead to vision impairment.

Furthermore, the reason why people develop myopia (also known as short-sightedness) is caused by the mismatch between the refractive error and the axial length. It may be that the axial length is too long, or the corneal curvature is too steep. When the refractive power of the eye is too high or too powerful, it will cause the light from the distant object to focus in front of the retina, and then cause the imaging point of the objects to fall in front of the retina, resulting in blurred vision. Therefore, in order to correct myopia, it is necessary to reduce the light bending ability of the eye. Since the light bending ability of the cornea accounts for about 80% of the whole eye, it is only necessary to reduce the refractive power of the cornea to achieve the effect of correcting myopia.

The methods used to correct refractive errors mainly include correction with glasses, correction with contact lenses, corneal myopia surgery or correction with orthokeratology. However, in order to facilitate daily life, many people choose to wear contact lenses to correct their eyesight. However, when most people wear contact lenses at present, the contact lenses are directly attached to the outside of the cornea of the eyeball. However, contact lenses are relatively light, thin, and small lenses, and when worn outside the cornea of the eyeball, it is easy to cause the contact lenses to move on the eyeball or detach from the eyeball due to eye rotation or eyelid blinking or shaking. It is quite unstable when wearing and needs to be improved urgently.

Therefore, how to solve the problems and troubles of instability and easy decentration of the current contact lenses when wearing them, and the troubles and deficiencies of the decentration of the contact lenses due to the rotation of the eyeballs, it is the direction that relevant manufacturers engaged in this industry are eager to study and improve.

### SUMMARY OF THE INVENTION

In view of the above-mentioned problems and deficiencies, the inventor collected relevant information, evaluated and considered in many ways, and based on years of experience accumulated in this industry, through continuous creation and modification, the inventor designed the stable structure design of contact lens.

It is therefore the main objective of the present invention to provide a stable structure design of contact lens, which comprises a central optical zone, a peripheral positioning zone surrounding the central optical zone, and an edge zone surrounding the peripheral positioning zone. Rotate axially along the outside of the central optical zone to obtain at least one preset thickness zone in sequence in the peripheral positioning zone sequentially, and according to the at least one preset thickness zone, multiple predetermined thickness values are obtained in the peripheral positioning zone. According to multiple predetermined thickness values, in order to make the thickness in the peripheral positioning zone conforming to the predetermined thickness values, the surface with at least one different thickness can be formed in the peripheral positioning zone, so as to provide the stable structure of contact lens.

Another objective of the present invention is that the surface of the contact lens (which may be the front surface) can be rotated clockwise or counterclockwise axially along the outside of the central optical zone, and in the clockwise or counterclockwise direction of the peripheral positioning zone, at least one preset thickness zone is sequentially obtained to form at least one regular or irregular surface with different thickness. The central optical zone is designed with one or more segments of curvature. The highest point distance (Sag) of the central optical zone is calculated by equation (1).

$$Sag = \frac{{R}_{0} - \sqrt{{R}_{0}^{2} - {y}^{2} p}}{p} ( mm ) ,$$

where R₀ is the curvature of the highest point of the central optical zone, p=1−e², e is the eccentricity, and y is the radius of the central optical zone; the bordering (b) of the central optical zone (circumferential edge connected with the peripheral positioning zone) is back-calculated from the contact lens diameter and edge curvature. The contact lens can be rotated clockwise or counterclockwise axially along the outside of the central optical zone to obtain at least one preset thickness zone in the peripheral positioning zone outwardly from the central optical zone toward the edge zone. For the positions of different thickness of the annular thickness curve of the at least one preset thickness zone of the surface of the peripheral positioning zone, the method of calculation is the function z=f(x) of the angle and thickness of the at least one preset thickness zone, that is, any point A in the function f(x) conforms to the equation (2):

$${lim}_{x \to {a}^{+}} f ( x ) = f ( a ) and {lim}_{x \to {a}^{-}} f ( x ) = f ( a ) ,$$

where the function z can be any function z=f(θ). The function z can be used as an aspheric equation function for calculating the different thicknesses of the at least one preset thickness zone of the surface of the peripheral positioning zone:

$$Z = \frac{C {X}^{2}}{1 + \sqrt{1 - ( K + 1 ) {C}^{2} {X}^{2}}} + {A}_{1} X + {A}_{2} {X}^{2} + {A}_{3} {X}^{3} + … + {A}_{n} {X}^{n} ( mm ) .$$

In addition, the aspheric angle (θ) of the function z=(θ) can also be calculated by Zernike equation (3):

$$W ( r , θ ) = {\sum }_{n , m} {C}_{n}^{m} {Z}_{n}^{m} ( r , θ ) ( mm ) ,$$

where Q is the coordinate position of any point A on the aspheric surface of the surface of the peripheral positioning zone of the function z. Or the contact lens can be rotated clockwise or counterclockwise axially along the outside of the central optical zone, then obtain the at least one thickness zone in the peripheral positioning zone inwardly from the edge zone toward the central optical zone.

Still another objective of the present invention is that the at least one preset thickness zone located in the peripheral positioning zone, it can be rotated clockwise or counterclockwise along the axial direction outside the central optical zone in the form of sinusoidal waveform, zigzag, trapezoidal or free curve to obtain the at least one preset thickness zone.

### BRIEF DESCRIPTION OF THE DRAWINGS

FIG. 1 is a design curve diagram of a contact lens according to the first embodiment of the present invention.

FIG. 2 is a schematic plan view of a contact lens according to the first embodiment of the present invention.

FIG. 3 is a design curve diagram of a contact lens according to the second embodiment of the present invention.

FIG. 4 is a schematic plan view of a contact lens according to the second embodiment of the present invention.

FIG. 5 is a design curve diagram of a contact lens according to the third embodiment of the present invention.

FIG. 6 is a schematic plan view of a contact lens according to the third embodiment of the present invention.

FIG. 7 is a design curve diagram of a contact lens according to the fourth embodiment of the present invention.

FIG. 8 is a schematic plan view of a contact lens according to the fourth embodiment of the present invention.

FIG. 9 is a partial side view of the contact lens of the present invention.

FIG. 10 is a schematic diagram of the peripheral positioning zone of the contact lens of the present invention.

FIG. 11 is a design curve diagram of a contact lens according to the fifth embodiment of the present invention.

FIG. 12 is a schematic plan view of a contact lens according to the fifth embodiment of the present invention.

### DETAILED DESCRIPTION OF THE PREFERRED EMBODIMENT

In order to achieve the above-mentioned purpose and effect, the technical means adopted in the present invention, its structure, and the method of implementation are hereby drawn in detail to illustrate the features and functions of the preferred embodiments of the present invention as follows, so as to facilitate a complete understanding.

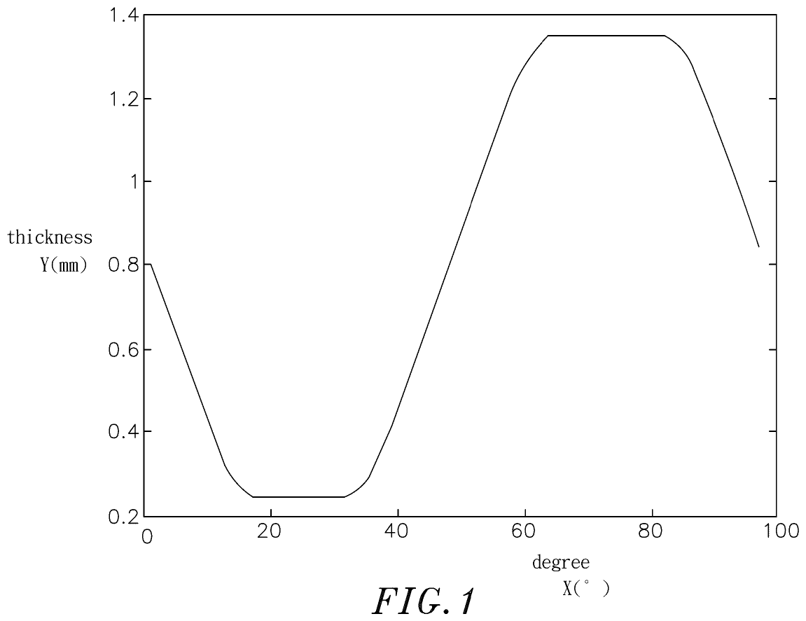

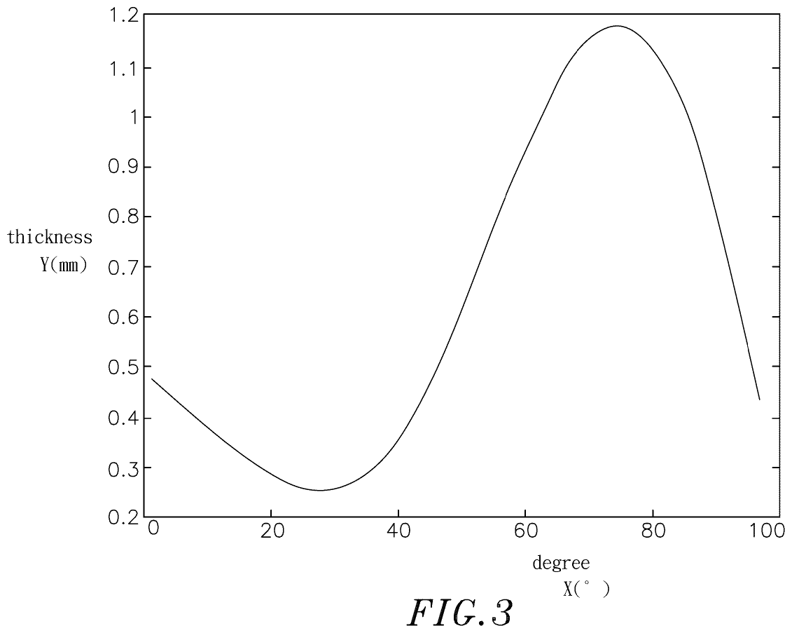

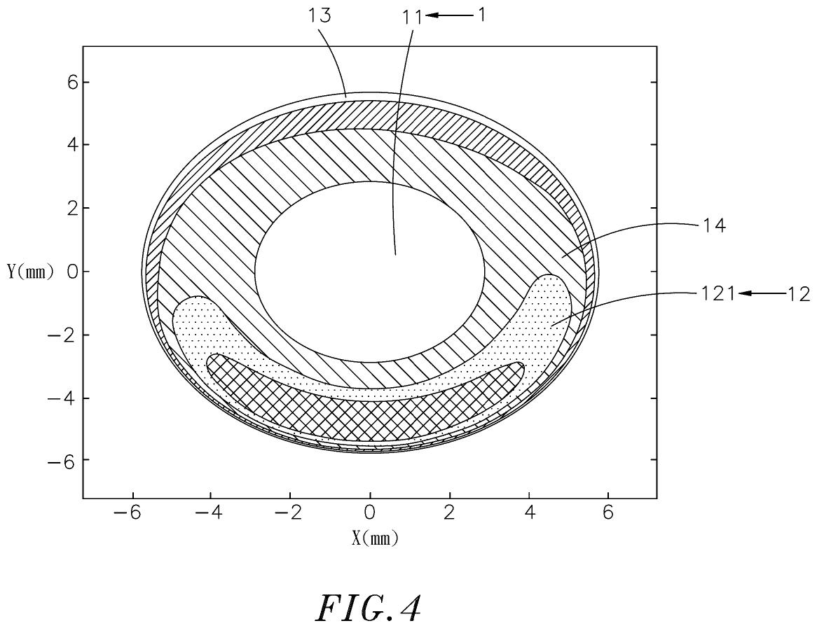

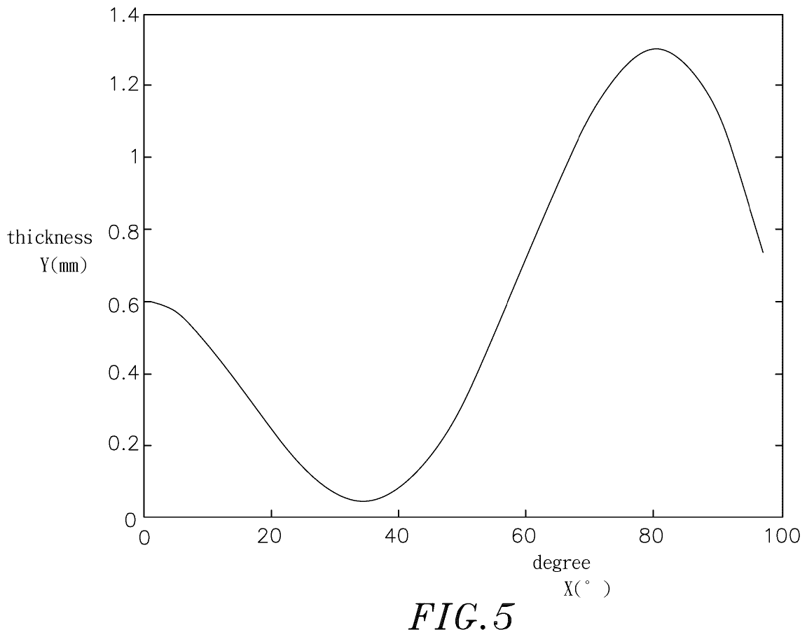

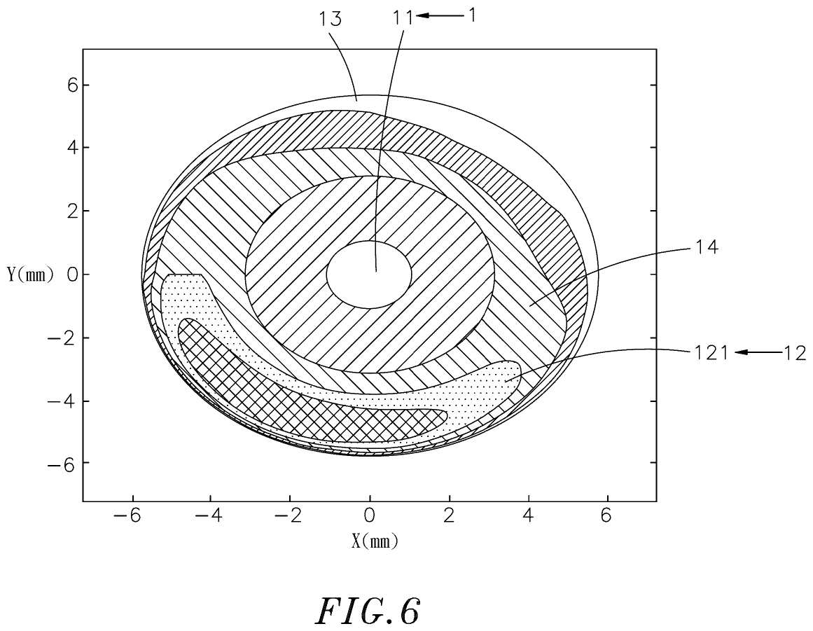

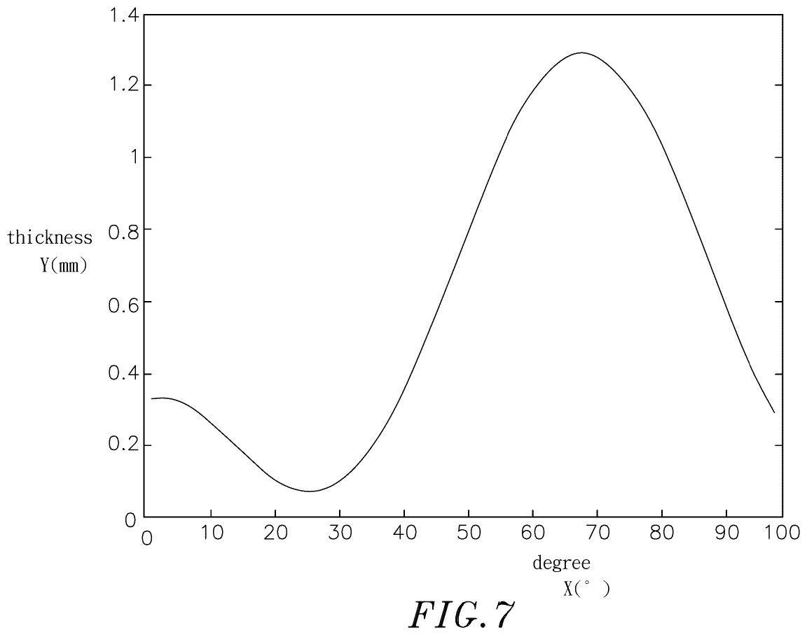

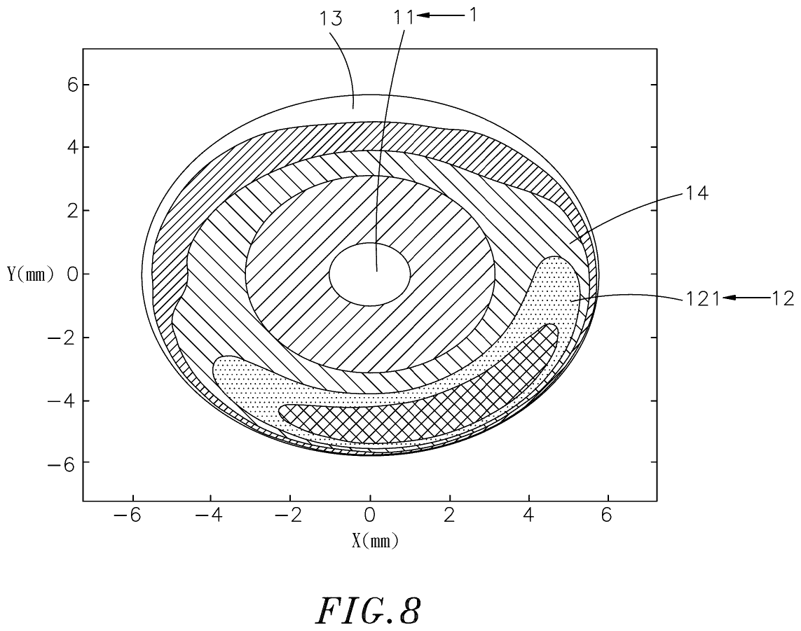

Referring to FIGS. 1-10, as shown in the drawings, it can be clearly seen that the stable structure design of the contact lens of the present invention, the contact lens 1 comprises a central optical zone 11, a peripheral positioning zone 12 surrounding the central optical zone 11, and an edge zone 13 surrounding the peripheral positioning zone 12, and the contact lens 1 can be designed according to the following steps.
(A01) The lens surface of the contact lens 1 can rotate axially around the outside of the central optical zone 11, and obtain the at least one preset thickness zone 121 in sequence in the peripheral positioning zone 12.
(A02) According to the at least one preset thickness zone 121, obtain multiple predetermined thickness values in the peripheral positioning zone 12.
(A03) Based on multiple predetermined thickness values, the thickness is made in the peripheral positioning zone 12 to meet the predetermined thickness values.
(A04) In the peripheral positioning zone 12, a surface 14 with at least one or more different thicknesses is formed.
(A05) Make the stable structure of contact lens 1.

As for the above-mentioned stable structure of contact lens of the present invention, the contact lens 1 comprises a central optical zone 11, a peripheral positioning zone 12 and an edge zone 13, wherein: The central optical zone 11 is located at the center of the contact lens 1.

The peripheral positioning zone 12 surrounds the central optical zone 11.

The edge zone 13 surrounds the peripheral positioning zone 12.

The above-mentioned peripheral positioning zone 12 surrounds the outside of the central optical zone 11 and the inside of the edge zone 13 along the axial direction to form a surface 14 with at least one different thickness.

The surface 14 of the peripheral positioning zone 12 of the above-mentioned contact lens 1 of the present invention can be the front surface of the peripheral positioning zone 12 (the outer surface of the contact lens 1 that is not in contact with the cornea of the eye). It can be rotated clockwise or counterclockwise along the axial direction outside the central optical zone 11, and in the peripheral positioning zone 12 along the clockwise or counterclockwise direction, at least one preset thickness zone 121 can be obtained sequentially, so that at least one or more regular or irregular curved surfaces 14 with different thicknesses can be formed in the peripheral positioning zone 12. The contact lens 1 can be rotated clockwise or counterclockwise axially along the outside of the central optical zone 11 to obtain at least one preset thickness zone 121 from the peripheral positioning zone 12 from the central optical zone 11 outwardly toward the edge zone 13. Or the contact lens 1 can be rotated clockwise or counterclockwise axially along the outside of the central optical zone 11, and then obtain at least one preset thickness zone 121 from the peripheral positioning zone 12 inwardly from the edge zone 13 toward the central optical zone 11.

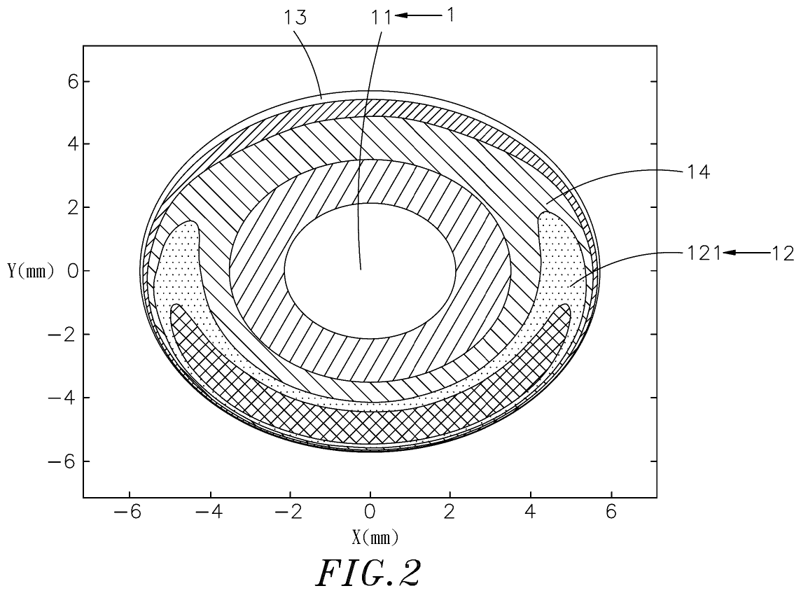

In the aforementioned contact lens 1 of the present invention, the at least one preset thickness zone 121 located in the peripheral positioning zone 12 is obtained by rotating clockwise or counterclockwise axially along the outside of the central optical zone 11 in a sinusoidal, zigzag, trapezoidal or free curve manner. According to the thickness value corresponding to the position of the curve (please also refer to FIGS. 1, 3, 5, and 7, wherein: the X axis is the angle (degree) of the contact lens, and the Y axis is the thickness value of the at least one preset thickness zone 121 (unit: millimeter)), the surface 14 of the at least one preset thickness zone 121 is made at the peripheral positioning zone 12 of the contact lens 1. It is a curved surface of a preset curved convex shape of the at least one preset thickness zone 121 (please also refer to FIGS. 2, 4, 6, and 8 at the same time, the X and Y axes are the angle (X axis) and thickness value (Y axis) corresponding to the contact lens 1 position respectively, and the units are: millimeter) that extends in a regular or irregular along the peripheral positioning zone 12. This design increases the quality of contact lens 1. The contact lens 1 can be stably worn on the cornea of the user's eye to cooperate with eyelid blinking or eyeball movement, to ensure that the contact lens 1 is not easy to decentration, deviate or displace, so as to achieve the purpose that the contact lens 1 is easily positioned on the cornea of the eye.

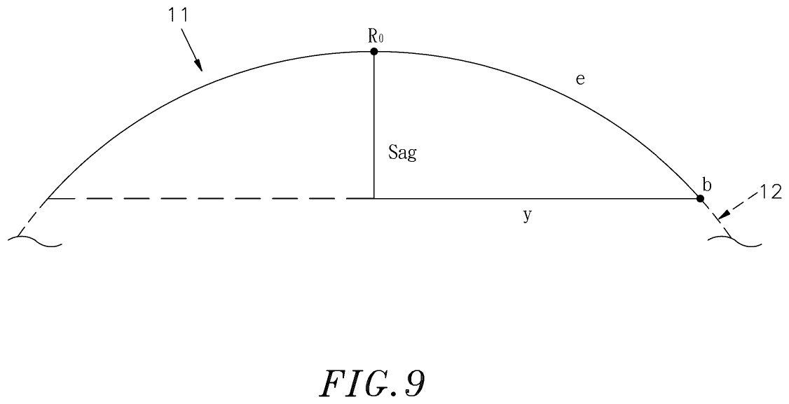

The central optical zone 11 of the above-mentioned contact lens 1 can be designed with one or more sections of curvature, and the highest point (the height distance (Sag) mm of T, please also refer to FIG. 9) of the central optical zone 11 can be calculated through equation (1):

$$Sag = \frac{{R}_{0} - \sqrt{{R}_{0}^{2} - {y}^{2} p}}{p} ( mm ) ,$$

where R₀ is the curvature of the highest point (T) of the central optical zone 11, p=1−e², e is the eccentricity, and y is the radius of the central optical zone 11, unit: millimeter (mm). The bordering (b) of the central optical zone 11 (circumferential edge connected with the peripheral positioning zone 12) can be back-calculated from the contact lens 1 diameter and edge curvature (this calculation is not a necessary technical content of the present invention, so the calculation method is not disclosed).

When designing the peripheral positioning zone 12 of the contact lens 1, it can be implemented through the following calculation steps:
(1) First determine the position of the annular thickness curve in the range of the peripheral positioning zone 12 (can be one or more).
(2) Determine the design of the annular thickness curve (can be one or more).
(3) Calculate the last point and the starting point of edge design of the peripheral positioning zone 12.
(4) Through more than three sets of data: the last point of the range of the peripheral positioning zone 12, thickness curve design, starting point of edge design, the optimal curve can be designed in different axes.
(5) Repeat the above step (4) to gradually complete the different radial thickness changes within the range of the peripheral positioning zone 12 from 0° to 360°.

Therefore, through the implementation of the above-mentioned steps, the positions of different thickness of the annular thickness curve of the at least one preset thickness zone 121 of the surface 14 of the peripheral positioning zone 12 of the contact lens 1 of the present invention, the method of calculation is the function z=f(x) of the angle and thickness of the at least one preset thickness zone 121, that is, any point A in the function f(x) conforms to the equation (2):

$${lim}_{x \to {a}^{+}} f ( x ) = f ( a ) and {lim}_{x \to {a}^{-}} f ( x ) = f ( a ) ,$$

where the function z can be any function z=f(θ), for example: polynomial, exponential function, Fourier, Gaussian, sum of sine or Weibull.

Furthermore, the above-mentioned function z can be used as an aspheric equation function for calculating the different thicknesses of the at least one preset thickness zone 121 of the surface 14 of the peripheral positioning zone 12:

$$Z = \frac{C {X}^{2}}{1 + \sqrt{1 - ( K + 1 ) {C}^{2} {X}^{2}}} + {A}_{1} X + {A}_{2} {X}^{2} + {A}_{3} {X}^{3} + … + {A}_{n} {X}^{n} ( mm ) .$$

In the above-mentioned aspherical equation z, C=1/R, R is the radius of curvature of the aspheric vertex, k=1−e, e is the eccentricity; when K=1, it means a hyperboloid; when K=−1, it means a paraboloid; 0>K>−1, which means a semi-elliptical spherical surface symmetrical to the major axis of the ellipse; K>0, which means a semi-elliptical spherical surface symmetrical to the minor axis of the ellipse; K=0, which means a spherical surface; the A1, A2, A3~An are any points obtained on the surface 14 of the peripheral positioning zone 12 (A, any point A of the above-mentioned function z=f(x)).

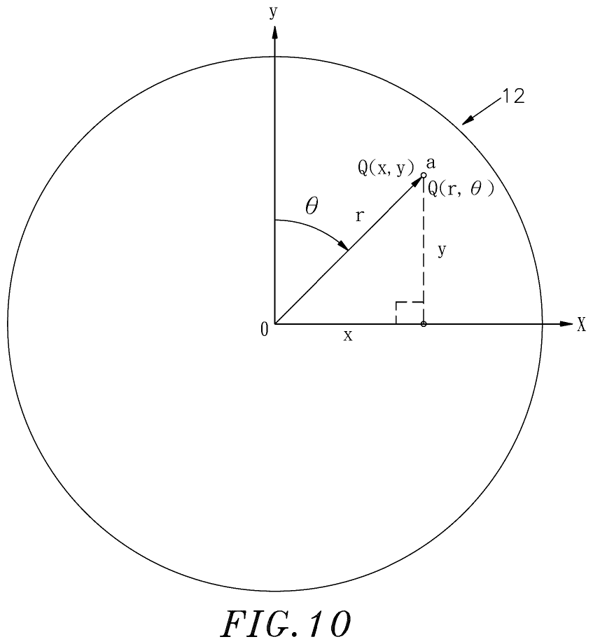

In addition, the aspheric angle (θ) of the function z=f(θ) can also be calculated by Zernike equation (3):

$$W ( r , θ ) = {\sum }_{n , m} {C}_{n}^{m} {Z}_{n}^{m} ( r , θ ) ( mm ) ,$$

where Q is the coordinate position of any point a (Q(x,y), Cartesian coordinates; Q(r,θ), polar coordinates) on the aspheric surface of the surface 14 of the peripheral positioning zone 12 of the function z (please also refer to FIG. 10). The equation (3) is the application of Zernike formula.

By repeating the calculation of the above-mentioned aspherical equation z or equation (3), it is possible to calculate the different thickness changes of the at least one preset thickness zone 121 in the radial shape presented by the peripheral positioning zone 12 from 0° to 360°, so as to obtain the design of the at least one preset thickness zone 121 on the surface 14 in the peripheral positioning zone 12 of the contact lens 1.

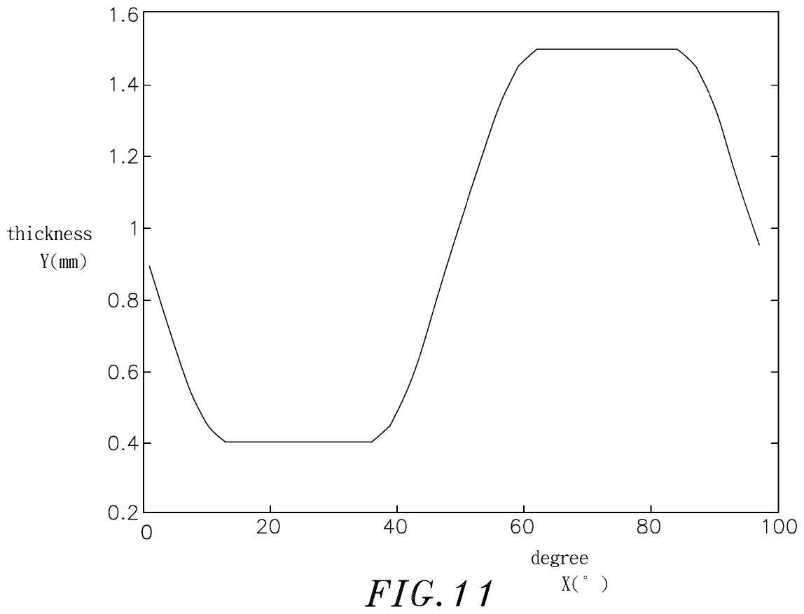

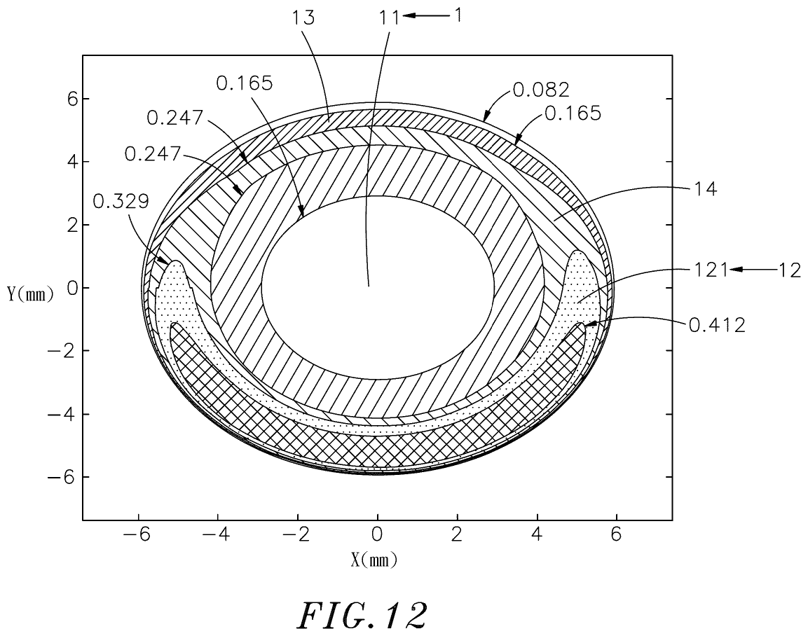

One of the preferred embodiments of the present invention, when it is desired to determine the design of the at least one preset thickness zone 121 on the surface 14 of the peripheral positioning zone 12, the position of the annular thickness curve can be preset, its radius (r)=6.8 (please also refer to FIGS. 11 and 12, the horizontal axis in FIG. 11 is: x, and the vertical axis is: y).

Carry out the design mode of preset annular thickness curve, which means the thickness change of the peripheral positioning zone 12 is different axial directions, from the function:

$${lim}_{x \to {a}^{+}} f ( x ) = f ( a ) and {lim}_{x \to {a}^{-}} f ( x ) = f ( a ) ,$$

substituting the radius (r)=6.8 of the position of the preset annular thickness curve into the function, you can get: f(50.001)=1.005, f(49.999)=1.005, then use the above equation (1):

$$Sag = \frac{{R}_{0} - \sqrt{{R}_{0}^{2} - {y}^{2} p}}{p} ( mm )$$

to calculate, the last point of the preset annular thickness curve (radius (r)=6.8 millimeters) on the peripheral positioning zone 12 can be obtained at (5, 1.47951), and the starting point is (7.4, 4.275574).

Further, the concept of calculating the axial direction of each axis of the preset annular thickness curve, assuming that the basic spherical program is selected: (x−x₀)²+(y−y₀)², the design point of the thickness curve (6.8, 3.050021) (can be obtained from the thickness function), then the value range the function (x−x₀)²+(y−y₀)²=r² can be calculated from the above-mentioned three points of the preset annular thickness curve: the last point (5, 1.47951), the starting point (7.4, 4.275574) and the design point of the thickness curve (6.8, 3.050021), where the variable x in the basic spherical program: 5~7.4 mm, and the variable y: 1.47951~4.275574 mm. By cooperating with the above diagrams, the design of the preset annular thickness curve can be completed, and the design of the at least one preset thickness zone 121 on the surface 14 of the peripheral positioning zone 12 can be obtained (the units of the calculation formulas above are: millimeter), and the number on the surface 14 of the peripheral positioning zone 12 can be obtained (please also refer to FIGS. 2, 4, 6, 8, and 12), and it is the design thickness dimension of the at least one preset thickness zone 121 (in the diagram above, the units in each formula are: mm).

Furthermore, the at least one preset thickness zone 121 located in the peripheral positioning zone 12 of the above-mentioned contact lens 1 of the present invention can be designed according to the user's eye condition, i.e., design the at least one preset thickness zone 121 in the peripheral positioning zone 12 of the contact lens 1 according to the same or different degree of myopia, hyperopia, astigmatism, presbyopia or eyelid shape of the left or right eye. Because the at least one preset thickness zone 121 located in the peripheral positioning zone 12 presents different or identical thickness values, it conforms to the movement of the eyeball (up, down, left, right, etc.) or the blinking action between the eyeball and eyelid, in order to cooperate with the contact lens 1 when the eyelids blink, so that it is not easy to push the contact lens 1 to move. In this way, the contact lens 1 is more stable to wear and to position on the cornea of the eye of the user, and is not easy to deviate, so as to achieve the purpose of stably attaching and positioning on the cornea of the eye.

The above are only the preferred embodiments of the present invention, and are not intended to limit the patent scope of the present invention. Therefore, all simple modifications and equivalent structural changes made by using the description and drawings of the present invention should be included in the patent scope of the present invention in the same way.

In summary, when the stable structure design of contact lens of the present invention is actually implemented and used, it can indeed achieve its efficacy and purpose.

What the invention claimed is:

1. A stable structure design of contact lens comprising: a central optical zone, a peripheral positioning zone and an edge zone, wherein:
said central optical zone is located at a center of the contact lens;
said peripheral positioning zone surrounds an outside of said central optical zone, and said peripheral positioning zone surrounds the outside of said central optical zone and an inside of said edge zone along an axial direction to form a surface with at least one different thickness;
said edge zone surrounds said peripheral positioning zone.

2. The stable structure design of contact lens as claimed in claim 1, wherein said central optical zone and said edge zone are spherical, aspherical, astigmatic, multifocal astigmatic or free-form optical designs, and said surface of said contact lens is a front surface; said contact lens can be rotated clockwise or counterclockwise axially along the outside of said central optical zone, and in said peripheral positioning zone along the clockwise or counterclockwise direction, obtain at least one preset thickness zone in order to form the at least one regular or irregular surface of different thickness; said central optical zone is designed with one or more segments of curvature; a highest point distance (Sag) of said central optical zone is calculated by equation (1):
$$Sag = \frac{{R}_{0} - \sqrt{{R}_{0}^{2} - {y}^{2} p}}{p} ( mm ) ,$$
where R₀ is the curvature of the highest point of said central optical zone, p=1−e², e is an eccentricity, and y is a radius of said central optical zone; a bordering (b) of said central optical zone (circumferential edge connected with said peripheral positioning zone) is back-calculated from the contact lens diameter and edge curvature.

3. The stable structure design of contact lens as claimed in claim 2, wherein said contact lens can be rotated clockwise or counterclockwise axially along an outside of said central optical zone to obtain the at least one preset thickness zone in said peripheral positioning zone outwardly from said central optical zone toward said edge zone; designing said peripheral positioning zone of said contact lens is implemented through the following calculation steps:
(1) first determining a position of an annular thickness curve in a range of said peripheral positioning zone (one or more);
(2) determining a design of the annular thickness curve (one or more);
(3) calculating a last point and a starting point of an edge design of said peripheral positioning zone;
(4) designing an optimal curve in different axes through three sets of data: the last point of the range of said peripheral positioning zone, the thickness curve design and the starting point of edge design; and
(5) repeating the step (4) to gradually complete the different radial thickness changes within the range of said peripheral positioning zone from 0° to 360°;
the positions of different thickness of the annular thickness curve of the at least one preset thickness zone of the surface of said peripheral positioning zone, the method of calculation is the function z=f(x) of the angle and thickness of the at least one preset thickness zone, that is, any point A in the function f(x) conforms to the equation (2):
$${lim}_{x \to {a}^{+}} f ( x ) = f ( a ) and {lim}_{x \to {a}^{-}} f ( x ) = f ( a ) ,$$
function z=f(θ); the function z is used as an aspheric equation function for calculating the different thicknesses of the at least one preset thickness zone of the surface of said peripheral positions zone:
$$Z = \frac{C {X}^{2}}{1 + \sqrt{1 - ( K + 1 ) {C}^{2} {X}^{2}}} + {A}_{1} X + {A}_{2} {X}^{2} + {A}_{3} {X}^{3} + … + {A}_{n} {X}^{n} ( mm ) ;$$
the aspheric angle (θ) of the function z=f(θ) is calculated by equation (3):
$$W ( r , θ ) = {\sum }_{n , m} {C}_{n}^{m} {Z}_{n}^{m} ( r , θ ) ( mm ) ,$$
where Q is a coordinate position of any point a (Q(x,y), Cartesian coordinates; Q(r,θ), polar coordinates) on the aspheric surface of the surface of said peripheral positioning zone of the function z.

4. The stable structure design of contact lens as claimed in claim 2, wherein said contact lens is rotated clockwise or counterclockwise axially along an outside of said central optical zone to obtain the at least one preset thickness zone in said peripheral positioning zone inwardly from said edge zone toward said central optical zone.
